(19) United States
(12) Patent Application Publication
(10) Pub. No.: US 2008/0304537 A1
(43) Pub. Date: Dec. 11, 2008

(54) Threaded Pin, Carbon Electrode, and Electrode Assembly

(75) Inventor: John Montminy, Karlsfeld (DE)

Correspondence Address: LERNER GREENBERG STEMER LLP, P O BOX 2480, HOLLYWOOD, FL, 33022-2480, US

(73) Assignee: SGL CARBON AG, Wiesbaden (DE)

(21) Appl. No.: 12/172,596

(22) Filed: Jul. 14, 2008

Related U.S. Application Data
(63) Continuation of application No. PCT/EP2007/000091, filed on Jan. 8, 2007.

(30) Foreign Application Priority Data
Jan. 12, 2006 (EP) 06 000 601.2

(51) Int. Cl. H05B 7/14; H05B 7/06

(52) U.S. Cl. 373/92; 373/91

(57) ABSTRACT

Carbon electrodes have at least one socket with an internal thread to be mated with a threaded pin having at least one external thread. Also such a threaded pin is provided for connecting to such carbon electrodes. The internal thread or external thread of the carbon electrodes and/or the pins are provided with non-load bearing abutment thread windings.

### CROSS-REFERENCE TO RELATED APPLICATION

This is a continuing application, under 35 U.S.C. § 120, of copending international application No. PCT/EP2007/000091, filed Jan. 8, 2007, which designated the United States; this application also claims the priority, under 35 U.S.C. § 119, of European patent application No. EP 06 000 601.2, filed Jan. 12, 2006; the prior applications are herewith incorporated by reference in their entirety.

### BACKGROUND OF THE INVENTION

### Field of the Invention

The invention relates to a threaded pin for connecting carbon electrodes having at least one socket with an internal thread. The pin has a central axis running along its length, two ends, a midplane lying between the two ends and at least one external thread. Further, the invention relates to a carbon electrode having at least one socket with an internal thread to be mated with a threaded pin. In addition, the invention relates to an electrode assembly with a threaded connection, containing an electrode and a pin.

Carbon electrodes, especially graphite electrodes, are used in the steel industry to melt metals in electrothermal furnaces like arc furnaces, where electric current is passed through the electrode forming an arc between the electrode and the metal to generate the heat necessary to melt the metal. The electric arc and the high temperatures in the furnace, which may be up to 1500° C. or even higher, cause the lower end of the electrode, which extends into the furnace in close proximity to the molten metal, to be slowly consumed. Therefore, generally a series of electrodes is joined to form an electrode column that is advanced progressively into the furnace. To compensate for the shortening of the electrode column further electrodes are screwed onto the top end of the column.

The electrodes are joined into the columns via a pin (sometimes referred to as a nipple) connecting the ends of adjoining electrodes. The pin usually has the form of two opposed male threaded ends that may have a cylindrical or conical shape. The pin is screwed into mating threaded sockets provided at both ends of the electrodes.

The pin is usually threaded firmly into one of the sockets of the electrode before shipping it to a customer. To avoid loosening of the pin due to vibrations and the like, the pin must be threaded firmly into the socket, leaving no clearances between thread flanks. This assembly of a pin threaded into the socket of the electrode is usually referred to as a monotrode, and the socket with the pin is referred to as a monotroded socket or a pre-set socket. For use in a furnace, the monotroded socket is joined to another electrode by screwing the protruding portion of the pin into its exposed socket to build a column.

When a furnace is in use, currents in excess of 100,000 A as well as flexing moments are exerted repeatedly on the electrode column due to the oscillation of the furnace casing. The column is also subjected to constant vibrations or impacts from the charge material, which may also place stress on the pin. The extreme mechanical, electrical and thermal stresses exerted on the pin may cause cracks in the pin and, more commonly, splitting in the upper monotroded socket, usually in the lower electrode column joint. This splitting in the upper monotroded socket of the lower electrode column joints is caused by the temperature gradients combined with the differing coefficients of thermal expansion (CTE) of the pin and the electrode. This is especially true, if the pin is screwed firmly into the socket for transportation. Because the faces of the threads of the pin and of the monotroded socket are in full contact, movement of the pin threads relative to the socket threads, and vice-versa, is inhibited leading to high internal hoop stresses in the socket. This problem is exacerbated, particularly as the joint approaches the hot metal bath in a furnace, where the temperature gradients are highest.

To avoid these undesired effects, the pin may be slightly unscrewed from the monotroded socket such that the threads are not fully engaged. In this constellation, only half of the faces of threads of the pin and of the monotroded socket are in contact, eventually bearing the full load of the electrode column. In order to prevent the partially engaged pin from being fully unscrewed from the monotroded socket, plastic pins are usually inserted into bores extending from the socket face of the electrode into the pin. Thus, clearances between the internal threads of the monotroded socket and the external threads of the pin are provided to allow a different CTE growth of the pin with respect to the monotroded socket. However, the procedure to center and fix the pin into a socket prior to shipment to the customer is cumbersome, time consuming, and highly dependent on the skill of the operator. Also, during transportation, the plastic pins are often not sufficient to restrain a nipple in a monotroded socket, and thread damage may result. This damage can leave internal debris in the monotroded socket that prevents proper tightening when the electrode is added to the furnace. Loosening may then progress to the point where electrode-to-electrode end-face contact is lost, which leads to an increase in the electrical resistance of the connection. More electrical current is then channelled through the connecting pin leading to localized overheating. As a result, the lower end of the electrode column may break off and fall into the molten steel, which interrupts the electric arc and terminates the smelting process.

Alternatively, metal or plastic pieces may be glued on the threads of the pin and/or the monotroded socket. This process is usually referred to as “tabbing”. The pin may then be screwed firmly into the monotroded socket for transportation and it is not necessary to loosen the pin from the monotroded socket prior to connecting the pin with a further electrode. In the furnace, the tabbing material on the threads melts away such that clearances are maintained between the internal threads of the monotroded socket and the external threads of the pin to allow for different CTE growths of the pin and monotroded socket. However, it is cumbersome to mount the tabbing pieces and difficult to obtain clearances of defined dimensions.

Furthermore, as the dimensions of carbon electrodes and connecting pins for arc furnaces are highly standardized in order to ensure interchangeability of electrodes and pins from various manufacturers, a solution is required that omits configuration changes to prior art electrodes and pins.

### SUMMARY OF THE INVENTION

It is accordingly an object of the invention to provide a threaded pin for carbon electrodes, a carbon electrode and an electrode assembly with a threaded pin which overcomes the above-mentioned disadvantages of the known devices which provide for a threaded connection that will prevent loosening and cracking.

With the foregoing and other objects in view, there is provided, in accordance with the invention, a threaded pin and a carbon electrode having non-load bearing abutment thread windings integrated into their threads.

The non-load bearing abutment thread windings on the pin provide for a defined abutment to position the pin with regard to a socket of a prior art electrode. Likewise, the non-load bearing abutment thread windings in the electrode socket provide for a defined abutment to position a prior art pin with regard to the electrode socket.

Hence, it is not possible to firmly screw a pin into an electrode such that the thread faces are in full contact. Moreover, the abutment thread windings of the pin or of the electrode come in contact with corresponding thread windings of a prior art electrode or prior art pin such that open clearances are provided between the internal thread of the electrode and the external thread of the pin. This prevents the pin threads from fully engaging the socket threads during setting in the finishing department prior to shipping of a monotroded socket. These open clearances, which were previously only possible by special measures, such as with the afore-mentioned pinning or tabbing of the pin, allow CTE growth of the pin with respect to the monotroded socket. Consequently, the occurrence of socket splits in the threaded connection, which can lead to full-length splits, body breaks, and loosening in the joint, is reduced. In addition, a monotroded socket, i.e. a pin screwed into the socket of an electrode, is still stable during transportation and handling as the forces exerted on the protrusion of the pin are sufficient to prevent loosening of the pin. Further, hoop stresses in the monotroded socket are alleviated, which further helps to minimize the formation of splits.

Furthermore, the invention does not require configuration changes to prior art electrodes and pins as a pin according to this invention can be used to connect (monotrode) prior art electrodes or an electrode according to the invention can be connected (monotroded) by prior art pins.

When an electrode is monotroded by inserting a pin prior to shipment, it is known to measure a so called “pin gauge protrusion”. This is a measure of how deeply seated the pin is in the electrode socket; that is, how far the pin protrudes outside of the socket as measured from the flat electrode end face with respect to a reference point on the pin using a pin gauge. The pin gauge protrusion is, at least indirectly, an indication of how far the pin will insert into a non-monotroded socket when assembled on an arc furnace. The total distance that the pin will insert into the non-monotroded socket of an electrode then depends on the monotroded socket tolerances, the tolerances of the monotroded end of the pin, the tolerances of the non-monotroded end of the pin and the non-monotroded socket tolerances.

The non-load bearing abutment thread windings at the thread of the pin or of the electrode according to the present invention ensure that the monotroded end of the pin will only insert a certain distance into the monotroded socket, and that there is clearance between the pin threads and socket threads. The pin gauge protrusion being exclusively determined by the non-load bearing abutment thread windings of the pin or of the electrode has consequently a relatively small variation. Therefore, pin gauge protrusion variation can roughly be cut in half by the invention. Moreover, the variation of the distance with that the non-monotroded end of the pin will insert into a non-monotroded socket on an electrode can be minimized (by half), as well. The net result is that the assembled electrode joint variation is lower by about half.

In this application, the term “pin midplane” is defined as the region where the two ends of the pin meet, irrespective of a possible different size of the two ends, i.e., the midplane of the threaded pin is not necessarily the geometric center with respect to the overall length or structure of the pin.

In a preferred embodiment of the invention, at least one of the pin ends, preferably both ends, containing the thread is/are conical in shape to facilitate the screwing into the electrode sockets and to improve the engagement. Usually thus the pin is provided with bi-conical external threads.

According to this invention, the non-load bearing abutment thread windings of the pin are provided at both pin ends at the thread area adjacent to the pin midplane. The non-load bearing abutment thread windings comprise up to 30% of the thread windings of each pin end.

According to a preferred embodiment of this invention, the non-load bearing abutment thread windings of the pin are provided at one pin end only. This pin end is the one designated to monotrode an electrode.

According to this invention, the non-load bearing abutment thread windings of the electrode are provided at both electrode sockets at the thread area adjacent to the socket bottom. These non-load bearing abutment thread windings comprise up to 30% of the thread windings at each socket.

According to a preferred embodiment of this invention, the non-load bearing abutment thread windings of the electrode are provided at one electrode socket only. The electrode socket is the one designated to be monotroded by a pin.

According to a preferred embodiment of this invention, the final non-load bearing abutment thread winding is followed by one single thread winding having no contact to the mating threads. This non-contact thread winding acts as a buffer zone between the non-load bearing abutment thread windings and the (conventional) load-bearing thread windings to prevent thermomechanical stress.

The present invention further is directed to an electrode assembly with a threaded connection containing an electrode made from a carbon material with a socket having an internal thread, a socket bottom and a central axis running along its length. The assembly further contains a pin made from a carbon material and has an external thread for connecting two electrodes, two ends and a central axis running along its length. Either the electrode or the pin has non-load bearing abutment thread windings at their threads, which, when the pin is screwed into the socket, come in contact with corresponding thread faces of the mating pin or electrode prior to one of the pin ends reaching the bottom of the corresponding socket.

This contact of the non-load bearing abutment thread windings of the inventive pin or electrode with the corresponding (conventional) thread windings of the mating electrode or pin coincides with the contact of the remaining (conventional) thread windings of the inventive pin or electrode with the corresponding (conventional) thread windings of the mating electrode or pin, eventually bearing the load of the electrode column.

Again, the defined abutment of the pin and the socket prior to one pin end reaching the socket bottom provides for open gaps or clearances between the internal thread of the socket and the external thread of the pin. These open clearances in turn allow for CTE growth of the pin with respect to the monotroded socket, thereby minimizing the risk of splits and the possibility of subsequent breaks in the pin, socket, or body.

It is preferred, to make both the electrode and the pin of synthetically produced carbon or graphite. This material imparts the property of plastic deformability. Therefore, the crests of a thread winding made from synthetically produced carbon or graphite do not simply break off but may be deformed. This further minimizes the likelihood of splits in the pin or the corresponding socket of an electrode.

The internal thread of an electrode socket and the external thread of a pin usually have thread windings with a substantially uniform pitch, a root, a crest and a substantially V-shaped profile. To provide for an approximately equal share of the load transferred between the two thread windings, it is preferred that at least one of the internal and external threads is formed with a wedge ramp at the root and that the crests of at least the other of the internal and external threads abut with the wedge ramps, when the pin is screwed into the socket. In a conventional threaded connection the top thread winding usually carries the largest load on its flank. The thread winding immediately below is subjected to a smaller load and the further thread windings below have to bear yet smaller loads. As a consequence, only a few thread windings participate in the transfer of loads. These higher stresses in the first thread windings may cause splitting of the pin and/or the socket. In contrast to that, when the crests of one thread winding abuts with the wedge ramps of the other thread winding, an approximately equal share of the load is transferred by all of the thread windings. With the pin or electrode provided with non-load bearing abutment thread windings according to the invention, the above-mentioned modified thread form may be used in the monotroded socket more easily, because the counter-forces ensure that proper contact between the standard threads and the wedge ramps is maintained during transportation, etc., prior to adding the monotroded electrode to an electrode to form an electrode column.

Other features which are considered as characteristic for the invention are set forth in the appended claims.

Although the invention is illustrated and described herein as embodied in a threaded pin, carbon electrode, and electrode assembly, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIGS. 1A and 1B are diagrammatic views showing a pin and a longitudinal section of an electrode prior to monotroding (joining);

FIGS. 2A and 2B are diagrammatic, longitudinal sectional views of two prior art electrodes joined by a prior art pin and a detailed view of the joint area;

FIGS. 3A and 3B are diagrammatic longitudinal sectional views of two prior art electrodes joined by a pin according to the invention and a detailed view of the joint area;

FIG. 4 is a diagrammatic, detailed longitudinal sectional view of a socket of the electrode according to the invention monotroded by a prior art pin;

FIGS. 5A and 5B are diagrammatic, detailed longitudinal sectional views of two different threaded connections between the electrode and the pin. In FIG. 5A, load vectors are drawn on the flanks of the thread windings, while in FIG. 5B these load vectors are applied to wedge ramps on roots of the thread windings; and

FIG. 6 is a diagrammatic, detailed longitudinal sectional view of the socket of a prior art electrode monotroded by a pin according to one embodiment of the invention.

### DETAILED DESCRIPTION OF THE INVENTION

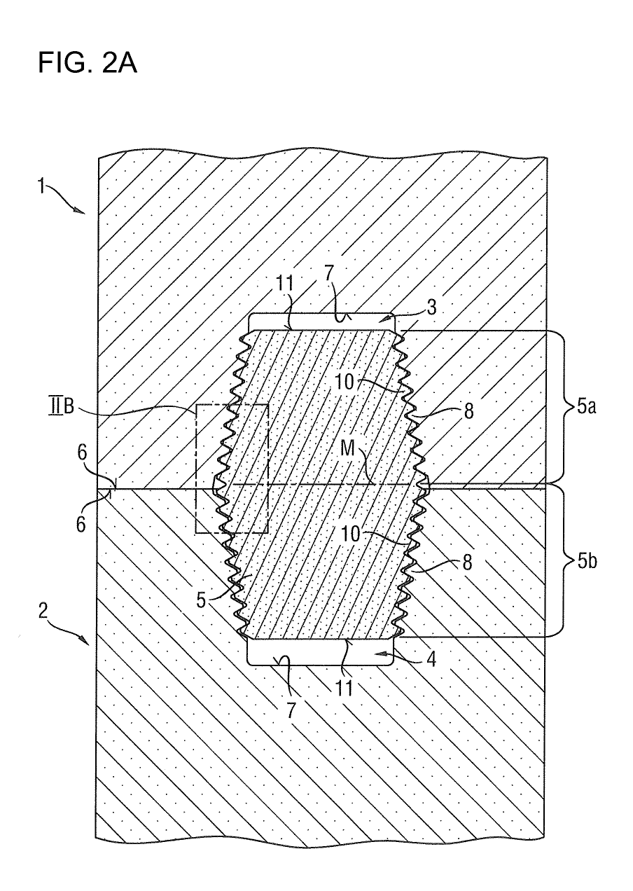

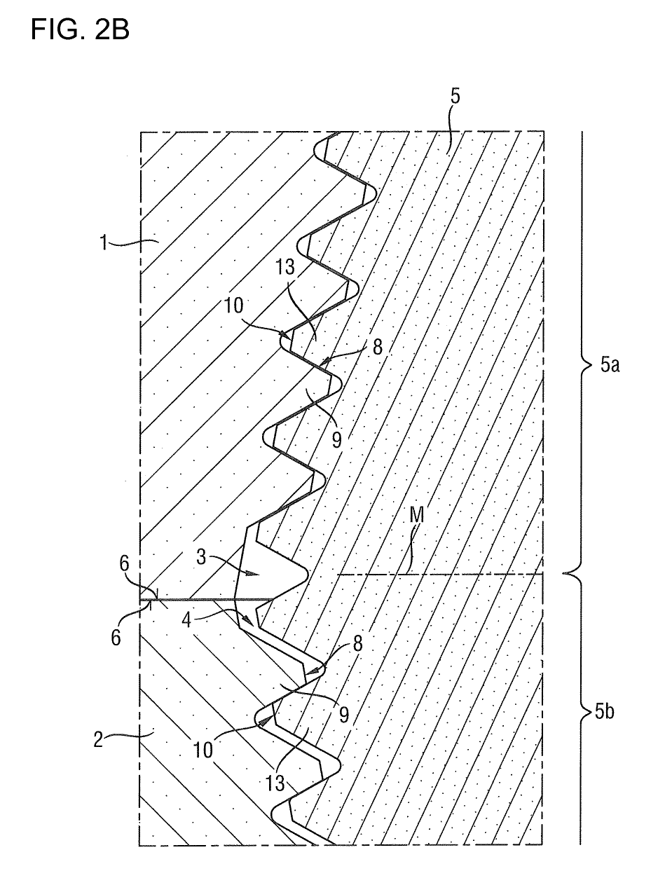

Referring now to the figures of the drawing in detail and first, particularly, to FIGS. 2A and 2B thereof, there is shown schematically depicted electrodes 1, 2, each having two sockets 3 and 4. The electrodes 1, 2 are coaxially fixed by a connecting pin 5 being screwed into the sockets 3, 4. The electrodes 1, 2 and the connecting pin 5 are made from a carbon material, preferably graphite.

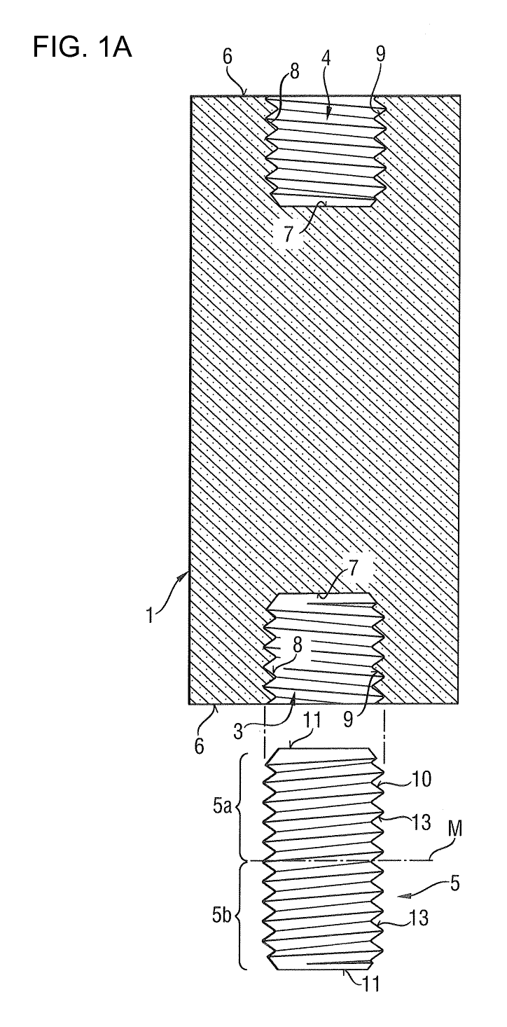

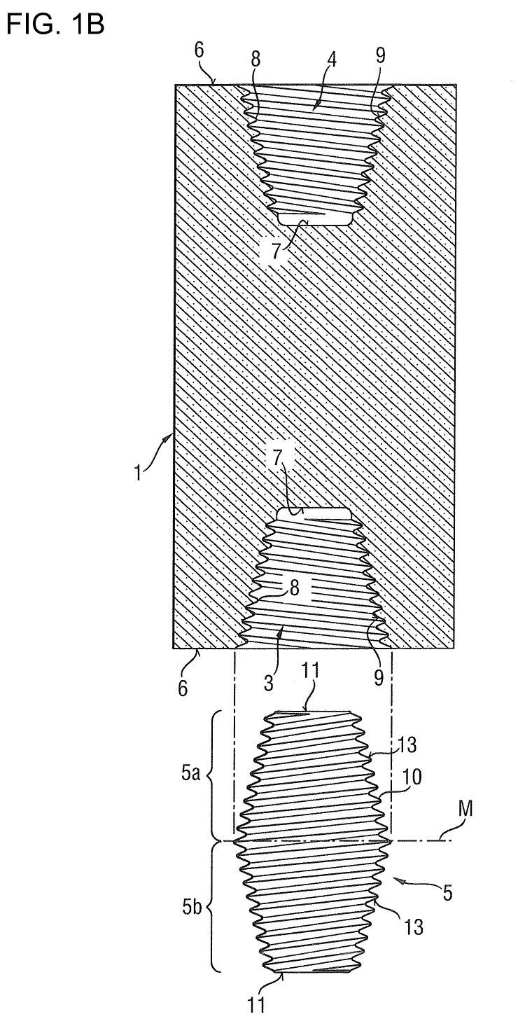

FIG. 1A and FIG. 1B provide a general view of arrangements of the electrode 1 and the connecting pin 5 prior to monotroding.

The coaxially disposed sockets 3, 4 of the electrode 1 are recessed into both electrode end faces 6. Each socket 3, 4 has a socket bottom 7 and is furnished with internal threads 8 having conventional thread windings 9. The connecting pin 5 has external threads 10 and possess flat end faces 11 on either side.

The lower socket 3 is also referred to as “monotroded socket” in the figures.

The connecting pin 5 has the form of two opposed male threaded ends 5a and 5b that may have a cylindrical (FIG. 1A) or conical external threads 10 (FIG. 1B). Accordingly, sockets 3, 4 have a cylindrical (FIG. 1A) or conical internal threads 8 (FIG. 1B). The (upper) pin end 5a is also referred to as “monotroded pin end” in the figures.

The two pin ends 5a, 5b meet at the pin midplane M, irrespective of a possible different size of the two pin ends 5a, 5b, i.e., the midplane M of the threaded pin 5 is not necessarily the geometric center with respect to the overall length or structure of the pin 5.

FIG. 2A shows the joint of a prior art electrode column formed of the electrodes 1, 2 joined together by pin 5. The connecting pin 5 is a standard connecting pin having the two conical end portions 5a, 5b and the midplane M lying between the two end portions. Conical external threads are provided on each of the two end portions 5a, 5b, which engage with internal threads of the sockets 3, 4. The electrode 1 was initially montroded with (prior art) pin 5 by screwing the pin 5 with its threaded end 5a firmly into the socket 3 for transportation. As shown in FIG. 2B, both pin ends 5a, 5b are provided exclusively with standard (conventional) thread windings 13. The faces of the pin thread 10 at its threaded end 5a of the and of the monotroded socket 3 are in full contact so that different CTE growth of the pin 5 and the socket 3 leads to cracks and other afore-mentioned problems. Further, the pin midplane M is displaced and the pin gauge protrusion with respect to the end-face 6 of the monotroded socket 3 is reduced.

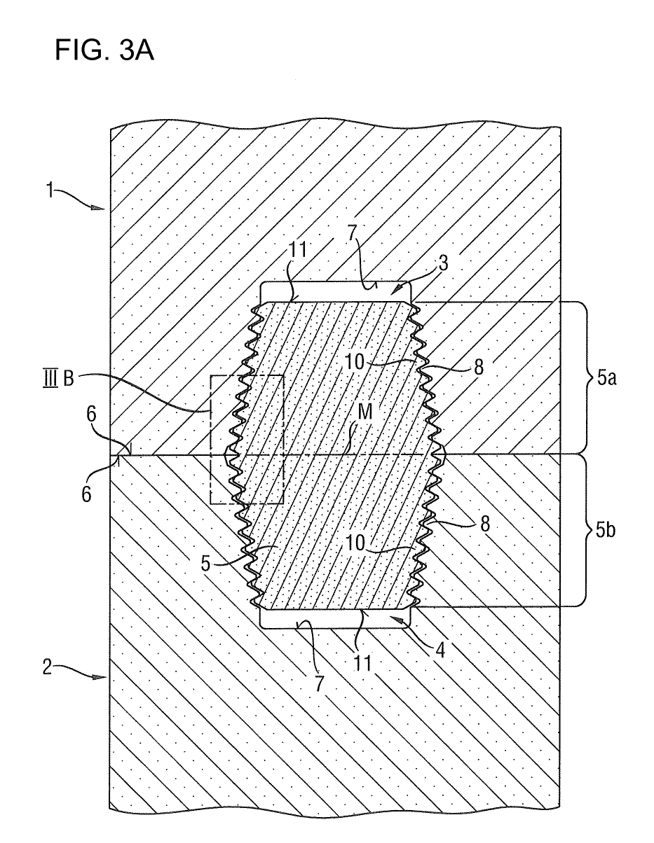

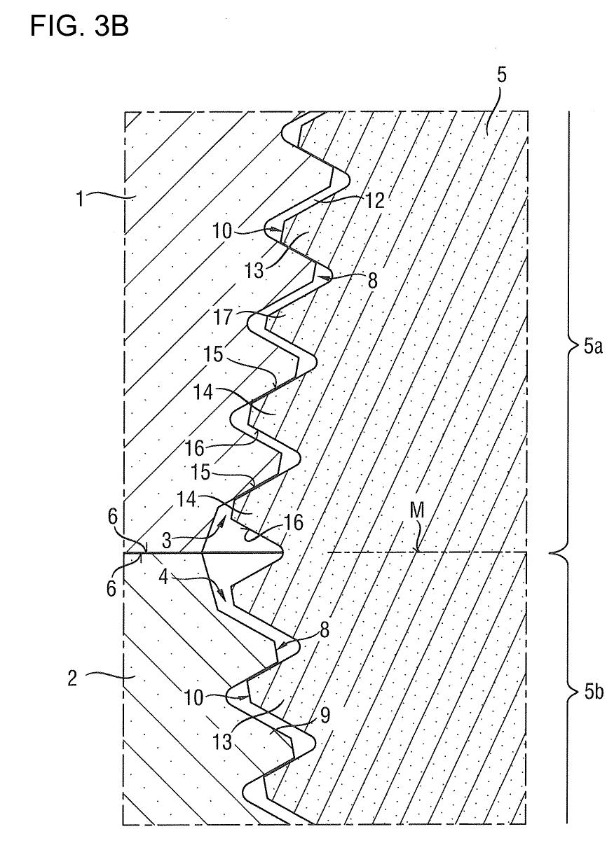

FIG. 3A shows the joint of an electrode column according to the invention formed of prior art electrodes 1, 2 joined together by a pin 5 according to the invention. The connecting pin 5 is a standard connecting pin, with regard to its geometry, having two conical end portions 5a, 5b and the midplane M lying between the two end portions. The conical external threads 10 are provided on each of the two end portions 5a, 5b, which engage with internal threads 8 of the sockets 3, 4. The socket 3 of electrode 1 was initially montroded by screwing the pin 5 with its threaded end 5a firmly into it. As shown in FIG. 3B, the external thread 10 of the lower pin end 5b has exclusively standard (conventional) thread windings 13, whereas the upper (monotroded) pin end 5a is additionally equipped with non-load bearing abutment thread windings 14 adjacent to the pin midplane M having abutment faces 15 facing towards pin end face 11.

According to the invention, the non-load bearing abutment thread windings 14 of the pin 5 are provided at both pin ends 5a, 5b at the thread area adjacent to the pin midplane M. According to a preferred embodiment of the invention (FIG. 3B), the non-load bearing abutment thread windings 14 of the pin 5 are provided at one pin end 5a only. This pin end 5a is the one designated to monotrode the electrode 1, 2.

The non-load bearing abutment thread windings 14 comprise up to 30% of the thread windings of a pin end 5a, 5b, depending on the length of the pin 5 and the diameter of the electrode 1, 2.

The thread windings 14 are shaped and positioned in relation to the conventional thread windings 13 of the pin 5 such that they provide non-load bearing abutment faces 15 abutting with the thread windings 9 of the monotroded socket 3.

The non-load bearing contact of the abutment thread windings 14 of the inventive pin 5 with the corresponding conventional thread 8 of the mating electrode 1 coincides with the engagement of the standard thread windings 13 of the inventive pin 5 with the thread windings 9 of the mating electrode 1, eventually bearing the load of the electrode column.

Thus, clearances 12 between the internal threads 8 of the monotroded socket 3 and the external threads 10 of the pin 5 are provided to allow for different CTE growths of the pin 5 and the monotroded socket 3.

The non-load bearing abutment thread windings 14 may have the same shape as the conventional thread windings 13 to simplify the machining procedures. Other shapes of the thread windings 14 including non-flat abutment faces 14 are within the scope of this invention. It is, however, important that the not abutting faces 16 of thread winding 14 are not in contact with the thread 8 of the mating electrode to provide a clearance 12.

It is a preferred embodiment of this invention, that the non-load bearing abutment thread windings 14 are followed by one single thread winding 17 having no contact to the internal threads 8 of the monotroded socket 3. This non-contact thread winding 17 acts as a buffer zone between the non-load bearing abutment thread windings 14 and the (conventional) thread windings 13 to prevent thermomechanical stress. The non-contact thread winding 17 may have a shape similar to the thread windings 13 or 14, yet somewhat reduced in size, to simplify machining. It may also be completely machined off, i.e. leaving a spare space instead of a winding flank.

As shown in FIG. 3A, the location of the pin midplane M coincides according to this invention with the plane of the flat end face 6 of the (monotroded) electrode 1 and, eventually, with the flat end face 6 of the connected (non-monotroded) electrode 2. The pin gauge protrusion is thus correct and the threaded joint clearance 11 between the internal thread 8 of the (non-monotroded) socket 4 of electrode 2 and the external thread 10 of the pin end 5b of pin 5 is provided to allow CTE growth of pin 5 within socket 4 of electrode 2 without causing further thermomechanical stresses in the pin or the socket.

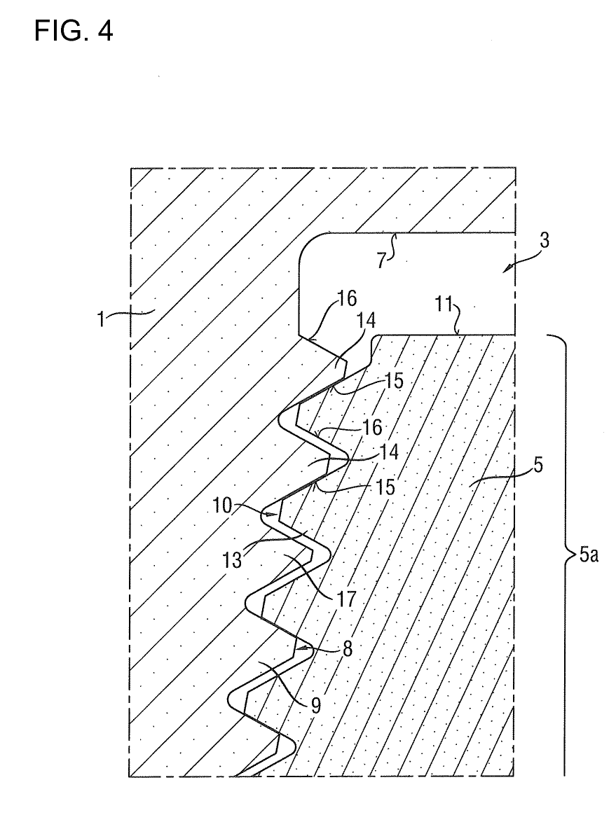

FIG. 4 shows the socket 3 of the electrode 1 according to the invention monotroded with a conventional pin 5. The external thread 10 of both pin ends 5a, 5b has exclusively standard (conventional) thread windings 13.

The monotroded socket 4 has standard (conventional) thread windings 9 and is additionally equipped with non-load bearing abutment thread windings 14 adjacent to the socket bottom 7 having the abutment faces 15 facing towards electrode end face 6.

According to the invention, the non-load bearing abutment thread windings 14 of electrode 1, 2 are provided at both sockets 3, 4 at the thread area adjacent to the socket bottom 7. According to a preferred embodiment of this invention, the non-load bearing abutment thread windings 14 of the electrode 1, 2 are provided at one socket 3 only. This socket 3 is the one designated to be monotrode by the conventional pin 5.

The non-load bearing abutment thread windings 14 comprise up to 30% of the thread windings of a socket 3, 4, depending on the length of the pin 5 and the diameter of the electrode 1, 2.

As further shown in FIG. 4, the non-load bearing contact of the abutment thread windings 14 of the inventive electrode 1 with the corresponding conventional thread 9 of the mating electrode 1 coincides with the engagement of the standard thread windings 13 of pin 5 with the (conventional) thread windings 10 of electrode 1, eventually bearing the load of the electrode column.

Further, the thread 9 of the electrode 1 is provided with a non-contact thread winding 17 acting as a buffer zone between the non-load bearing abutment thread windings 14 and the conventional thread windings 10 to prevent thermomechanical stress.

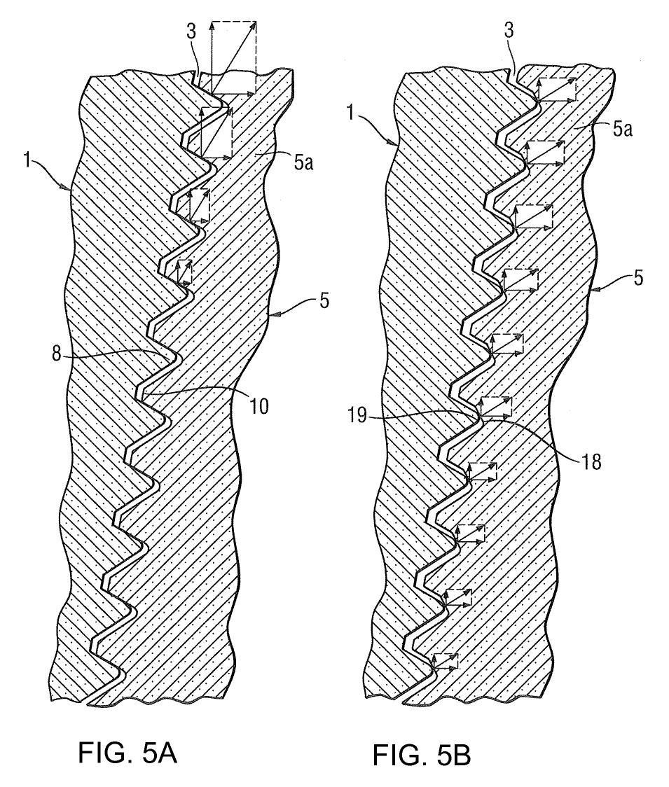

FIGS. 5A and 5B illustrate the improved transfer of mechanical loads by comparison of a traditional threaded connection (FIG. 5A) with a threaded connection between an electrode 1 and a pin 5 according to published, European patent application EP 1 528 840 A1 (FIG. 5B). Particularly the load vectors drawn on the flanks of the pin thread windings 13 clarify the differences.

The threads 8, 12 of electrodes 1, 2 and pin 5 have windings 9, 13 with a substantially uniform pitch, a root, a crest 19 and a substantially V-shaped profile. In the traditional threaded connection, see FIG. 5A, the top thread winding 13 has the largest load vector on its flank. The thread winding 13 immediately below is subjected to a smaller load vector, the thread winding 13 below that has a yet smaller load, and so on. The bottom thread windings 13 barely participate in the transfer of loads from electrode 1 to pin 5.

According to published, European patent application EP 1 528 840 A1 one of the threads 8, 12 is formed with wedge ramps 18 at the root of windings 9, 13 and the crests 19 of the mating thread windings 9, 13 abut with the wedge ramps 18 when pin 5 is screwed into socket 3, 4. In the threaded connection between the electrode 1 and a pin 5 according to patent application EP 1 528 840 A1, see FIG. 5B, the load vectors drawn on the wedge ramps 18 on the roots of the thread windings 13 are of practically equal size for all wedge ramps 18. Therefore an approximately equal share of the load is transferred at each contact face from the crest 19 of the thread winding 9 of electrode 1 to the wedge ramp 18 on the root of the thread winding 13 of pin 5.

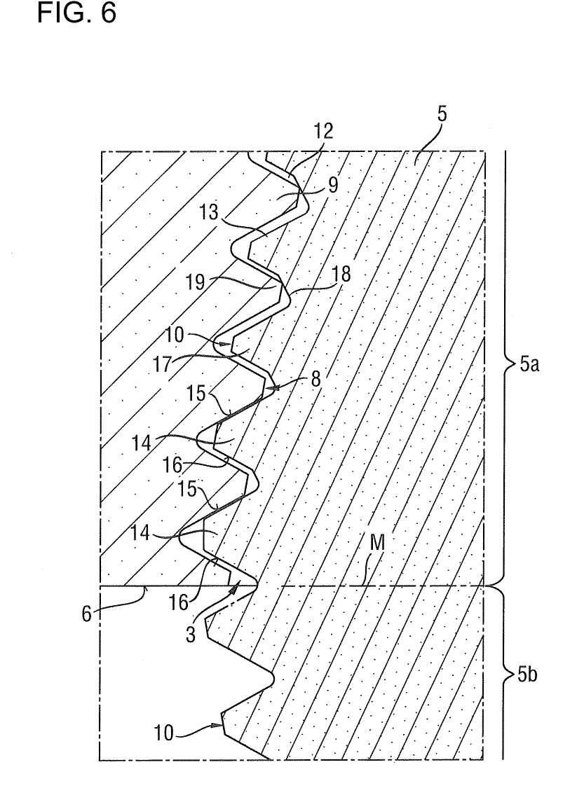

FIG. 6 shows the socket 3 of a conventional electrode 1 monotroded with a pin 5 having a thread 10 formed according to EP 1 528 840 A1 with wedge ramps 18 at the root of windings 13 where the crests 19 of the mating electrode thread windings 9 abut with the wedge ramps 18 when pin 5 is screwed into socket 3. According to this invention, thread 10 further contains non-load bearing abutment thread windings 14 and preferably a non-contact thread winding 17. Hence, it is shown that the invention can be also applied to novel thread configurations without being limited to traditional threads.

1. A threaded electrode, comprising:
two electrode end faces;
two sockets each having a socket bottom and an internal thread, said internal thread of at least one of said sockets having non-load bearing abutment thread windings with abutment faces facing towards said electrode end faces; and
a central axis running along a length.

2. The electrode according to claim 1, wherein said internal thread of only one of said two sockets has said non-load bearing abutment thread windings.

3. The electrode according to claim 1, wherein said internal thread has windings and up to 30% of said windings of said internal thread are non-load bearing abutment thread windings.

4. The electrode according to claim 1, wherein said non-load bearing abutment thread windings are provided at a thread area adjacent to said socket bottom.

5. The electrode according to claim 1, wherein said internal thread has one non-contact thread winding following said non-load bearing abutment thread windings.

6. The electrode according to claim 1, wherein said internal thread has thread windings with a substantially uniform pitch, a root, a crest and a substantially V-shaped profile, and said internal thread is formed with a wedge ramp at said root, and crests of an external thread of a pin abut with said wedge ramps, when the pin is screwed into the electrode.

7. The electrode according to claim 1, wherein the electrode is made of a material selected from the group consisting of carbon and graphite.

8. The electrode according to claim 1, wherein said internal thread has a conical shape.

9. A threaded pin for connecting carbon electrodes having two sockets with an internal thread, the threaded pin comprising:
a pin body having a length, a central axis running along said length, two end faces, two end portions, a midplane lying between said two end portions, and at least one external thread, said external thread having non-load bearing abutment thread windings having abutment faces facing towards said pin end faces.

10. The threaded pin according to claim 9, wherein said external thread of only one of said two end portions has said non-load bearing abutment thread windings.

11. The threaded pin according to claim 9, wherein said external thread has windings and up to 30% of said windings of said external thread are said non-load bearing abutment thread windings.

12. The threaded pin according to claim 9, wherein said non-load bearing abutment thread windings are provided at a thread area adjacent to said midplane.

13. The threaded pin according to claim 9, wherein said external thread having one contact thread winding following said non-load bearing abutment thread windings.

14. The threaded pin according to claim 9, wherein said external thread has thread windings with a substantially uniform pitch, a root, a crest and a substantially V-shaped profile, and said external thread is formed with a wedge ramp at said root, and crests of the internal thread of the electrode abut with said wedge ramps when the threaded pin is screwed into the electrode.

15. The threaded pin according to claim 9, wherein the threaded pin is made of a material selected from the group consisting of carbon and graphite.

16. The threaded pin according to claim 9, wherein said external thread has a conical shape.

17. A pre-set, comprising:
an electrode containing two electrode end faces, a central axis running along a length, and two sockets each having a socket bottom and an internal thread, said internal thread of at least one of said sockets having non-load bearing abutment thread windings with abutment faces facing towards said electrode end faces; and
a pin monotroded in one of said sockets of said electrode having said non-load bearing abutment thread windings, said pin having a midplane aligned with one of said electrode end faces at said one socket.

18. A pre-set, comprising:
a pin containing a pin body having a length, a central axis running along said length, two end faces, two end portions, a midplane lying between said two end portions, and at least one external thread, said external thread having non-load bearing abutment thread windings with abutment faces facing towards said pin end faces; and
an electrode having an electrode end face and a socket monotroded with one of said end portions provided with said non-load bearing abutment thread windings, said midplane aligned with said electrode end face at said socket.

19. An electrode assembly, comprising:
pre-sets each containing:
an electrode containing two electrode end faces, a central axis running along a length, and two sockets each having a socket bottom and an internal thread, said internal thread of at least one of said sockets having non-load bearing abutment thread windings with abutment faces facing towards said electrode end faces; and
a pin monotroded in one of said sockets of said electrode having said non-load bearing abutment thread windings, said pin having a midplane aligned with one of said electrode end faces at said one socket.

20. An electrode assembly, comprising:
pre-sets each containing:
a pin containing a pin body having a length, a central axis running along said length, two end faces, two end portions, a midplane lying between said two end portions, and at least one external thread, said external thread having non-load bearing abutment thread windings having abutment faces facing towards said pin end faces; and
an electrode having an electrode end face and a socket monotroded with one of said end portions provided with said non-load bearing abutment thread windings, said midplane aligned with said electrode end face at said socket.
